(19) United States
(12) Patent Application Publication
(10) Pub. No.: US 2020/0166073 A1
(43) Pub. Date: May 28, 2020

(54) CARABINER INCLUDING GATE SECTION INCORPORATING A BOTTLE OPENER FEATURE

(71) Applicant: FORD GLOBAL TECHNOLOGIES, LLC, Dearborn, MI (US)

(72) Inventors: Maria Fernanda Medina Luna, Naucalpan (MX); Eric Bryan Arellano Aguilar, Azcapotzalco (MX); Scott Anderson, Commerce Twp, MI (US); Miguel Angel Ramirez Basilio, Coacalco (MX)

(21) Appl. No.: 16/203,193

(22) Filed: Nov. 28, 2018

(51) Int. Cl. F16B 45/02; B67B 7/16

(52) U.S. Cl. CPC F16B 45/02; B67B 7/16

(57) ABSTRACT

An apparatus includes a trim panel and a carabiner releasably attached to the trim panel. The carabiner includes a body, having a hook section and a gate section defining a receiver, a pivot connecting the gate section to the hook section and a bottle opener feature projecting from the gate section outboard of the receiver. A method of opening a bottle is also disclosed.

### TECHNICAL FIELD

This document relates generally to the connector field and, more particularly, to a new and improved carabiner wherein the gate section incorporates a bottle opener feature that may be utilized to remove a bottle cap from a bottle even without opening the receiver of the carabiner.

### BACKGROUND

A carabiner is a well-known type of a connector. A carabiner includes a hook section and a gate section that usually form a D-shaped or oblong body outlining a receiver. The gate section is connected by a spring-hinge to the hook section and may be pivoted open to allow access to the receiver and then pivoted closed to contain an attachment in the receiver within the body of the carabiner.

Carabiners may be utilized for a number of different applications in various environments. For example, a carabiner may be incorporated into a motor vehicle to act as a tie-down for different items in a cargo compartment such as the cargo area behind the rear seat of a sport utility vehicle. In such an embodiment, the carabiner may be mounted to the floor, the sidewall trim or the rear seat defining the storage compartment.

This document relates to a new and improved carabiner wherein the gate section incorporates a bottle opener feature. That gate section may be removed and then utilized to conveniently and effortlessly remove a bottle cap from a bottle. Alternatively, the gate section may be maintained connected to the hook section and used to remove a bottle cap from a bottle even without opening the gate section and removing any attachment from the receiver of the carabiner.

### SUMMARY

In accordance with the purposes and benefits described herein, a new and improved carabiner is provided. That carabiner comprises: (a) a body having a hook section and a gate section defining a receiver, (b) a pivot connecting the gate section to the hook section and (c) a bottle opener feature projecting from the gate section outboard of the receiver.

More particularly, the bottle opener feature may include (a) a first lug, (b) a second lug and (c) a jaw defined between the first lug and the second lug. The first lug may be U-shaped. The second lug may be U-shaped.

The hook section may extend through the first jaw. The pivot may include trunnion carried on the gate section and a bearing carried on a first end of the hook section. The trunnion may extend across the second lug.

The gate section may include a cantilever spring. A catch may be carried on the hook section on the first end adjacent the bearing. Further, the cantilever spring may include a pin engaged in the catch.

In accordance with an additional aspect, an apparatus is provided comprising a trim panel, such as found in the cargo compartment of a motor vehicle, and a carabiner releasably attached to the trim panel. That carabiner may include a body having a hook section and a gate section defining a receiver. The carabiner may further include a pivot connecting the gate section to the hook section. Further, the carabiner may include a bottle opener feature carried on the gate section and projecting from the gate section outboard of the receiver.

Still further, the bottle opener feature may include (a) a first lug, (b) a second lug and (c) a jaw defined between the first lug and the second lug. Advantageously, that bottle opener feature may be utilized to remove a bottle cap from a bottle either with the gate section connected to the hook section or with the gate section removed from the hook section. Further, it should be appreciated that the bottle opener feature may be utilized to remove the bottle cap without requiring one to open the receiver and remove any attachment from the receiver of the carabiner. Thus, it should be appreciated that the bottle opener feature is versatile and easy to use.

In accordance with yet another aspect, a new and improved method is provided of opening a bottle. That method comprises the steps of: (a) removing a carabiner from a trim panel of a motor vehicle, (b) positioning a jaw of a bottle opener feature carried on the carabiner into engagement with a bottle cap on the bottle and (c) prying the bottle cap off of the bottle using the jaw. Still further, the method may include the step of (d) opening the bottle without opening the receiver of the carabiner. Alternatively, or in addition to step (d), the method may include opening the bottle without removing any attachment from the receiver of the carabiner.

In the following description, there are shown and described several preferred embodiments of the carabiner, the apparatus and the related method of opening a bottle. As it should be realized, the carabiner, apparatus and method are all capable of other, different embodiments and their several details are capable of modification in various, obvious aspects all without departing from the carabiner, the apparatus and the method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the carabiner, the apparatus and the method and together with the description, serve to explain certain principles thereof.

FIGS. 1A and 1B are two perspective views of an apparatus including a trim panel of a motor vehicle and a carabiner releasably attached to the trim panel.

In FIG. 1A, the gate section of the carabiner is illustrated in the first or closed position.

In FIG. 1B, the gate section of the carabiner is illustrated in the second or opened position allowing access to the receiver defined by the body of the carabiner.

FIG. 2 is a schematic cross sectional view of the apparatus illustrated in FIG. 1 showing one possible embodiment of a releasable attachment feature utilized to connect the carabiner to the trim panel.

FIG. 3A is a detailed perspective view of the carabiner, removed from the trim panel.

FIG. 3B is a perspective view similar to FIG. 3A but illustrating the gate section of the carabiner detached from the hook section of the carabiner.

FIG. 4A is a perspective view illustrating how the bottle opener feature of the carabiner is engaged with a bottle cap on a bottle.

FIG. 4B is a view similar to FIG. 4A illustrating by action arrow how the carabiner is used to pry the bottle cap from the bottle, thereby opening the bottle.

Reference will now be made in detail to the present preferred embodiments of the carabiner, the apparatus and the method, examples of which are illustrated in the accompanying drawing figures.

### DETAILED DESCRIPTION

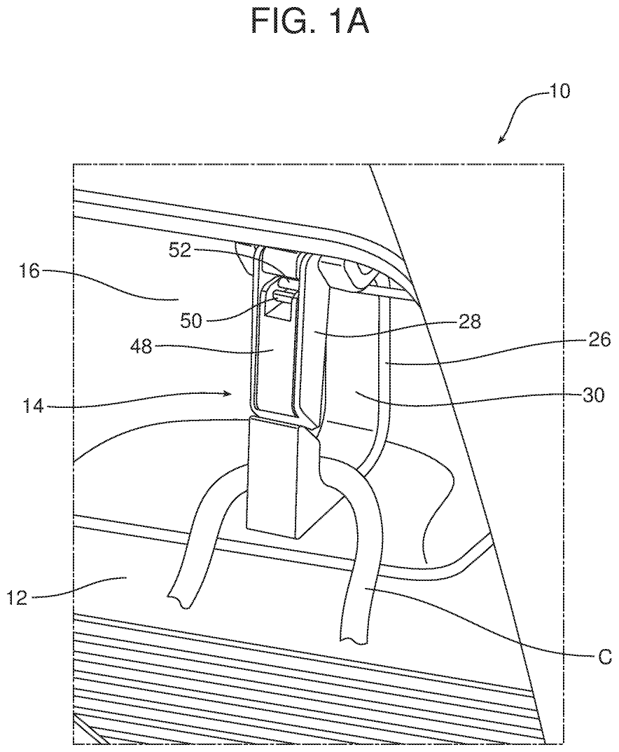

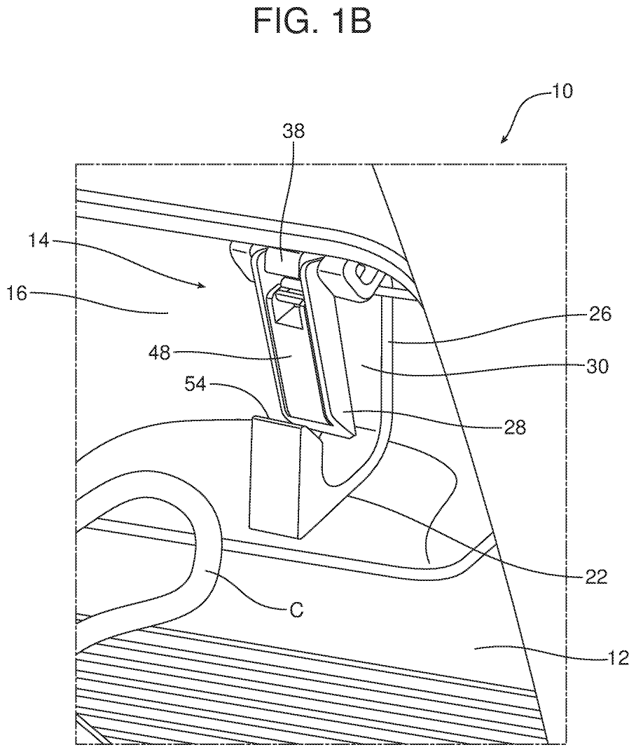

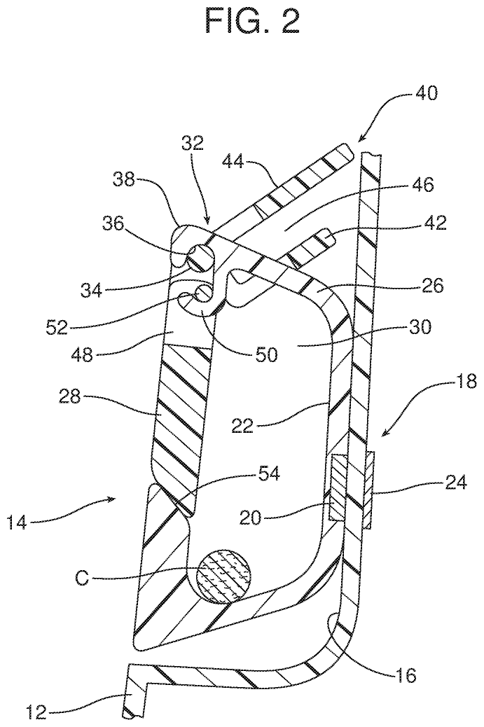

Reference is now made to FIGS. 1A and 1B illustrating a new and improved apparatus 10 including a trim panel 12 and a carabiner 14 releasably attached to the trim panel. More particularly, as illustrated in FIGS. 1A, 1B and 2, the trim panel 12 includes a concavity 16 for receiving and holding the carabiner. That carabiner 14 may be attached to the trim panel 12 by means of a releasable attachment feature, generally designated by reference numeral 18. More particularly, in the illustrated embodiment, the releasable attachment feature comprises a magnet 20 embedded in the body 22 of the carabiner 14 and a cooperating steel plate 24 carried on the trim panel 12. Here it should be appreciated that other releasable fasteners of any type known in the art may be utilized to secure the carabiner 14 to the trim panel 12.

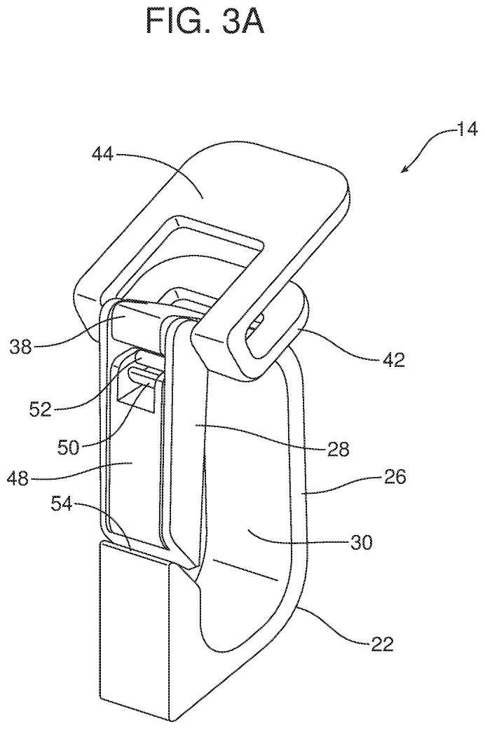

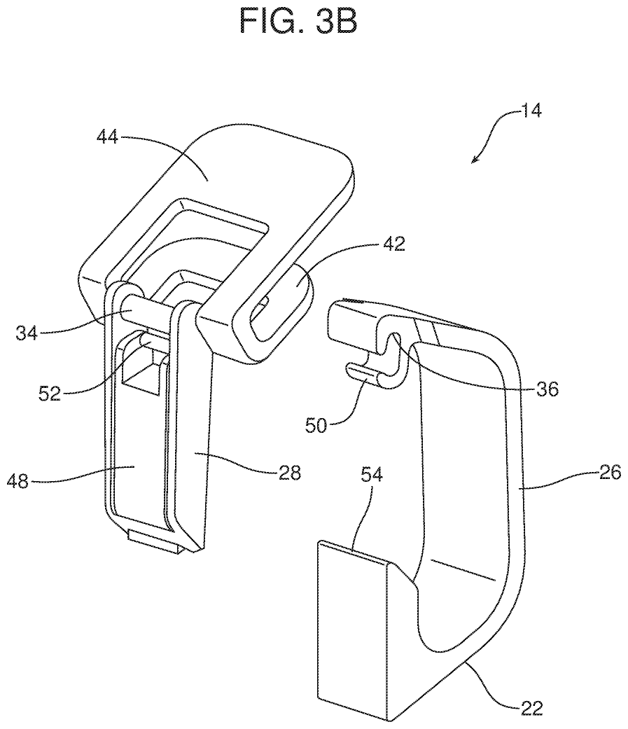

As best illustrated in FIGS. 1A, 1B, 3A and 3B, the body 22 of the carabiner 14 includes a hook section 26 and a gate section 28 defining a central opening or receiver 30. As is known in the art, the receiver 30 is adapted to receive and hold an attachment feature such as a line or cord C.

A pivot, generally designated by reference numeral 32, connects the gate section 28 to the hook section 26. More particularly, as best illustrated in FIG. 2, the pivot 32 includes a trunnion 34, carried on the gate section 28, and a bearing 36 carried on a first end 38 of the hook section 26.

As should also be appreciated from viewing FIGS. 1A, 1B, 3A and 3B, the carabiner 14 also includes a bottle opener feature, generally designated by reference numeral 40, that is carried on the gate section 28 and projects from the gate section outboard of the receiver 30.

More particularly, the bottle opener feature 40 includes a first lug 42, a second lug 44 and jaw 46 defined between the first lug and the second lug. In the illustrated embodiment, the first lug 42 is U-shaped. Similarly, the second lug 44 is U-shaped. In the illustrated embodiment, it should be appreciated that the hook section 26 extends through the first lug 42. Further, the trunnion 34 extends across the second lug 44.

The gate section 28 includes a cantilever spring 48. In the illustrated embodiment, the cantilever spring is formed as an integral portion of the gate section 28. This cantilever spring 48 tends to bias the gate section 28 toward the closed position illustrated in FIGS. 1A and 3A. The hook section 26 and the gate section 28 may be made from a number of different materials including, but not necessarily limited to, metal, plastic, aluminum, acrylonitrile butadiene styrene (ABS) filled plastic and combinations thereof.

A catch 50 is carried on the hook section 26 at the first end 38 adjacent the bearing 36. The cantilever spring 48 includes an integral pin 52 that engages in the catch 50 when the gate section 28 is connected to the hook section 26.

When the gate section 28 is in the closed position, the distal end 52 of the gate section 28 is aligned with and juxtaposed to the second end 54 of the hook section 26 thereby completely closing the receiver 30 formed within the body 22. When closed, any attachment or cord C is retained within the receiver 30 of the carabiner 14. In contrast, when gate section 28 is displaced against the biasing force of the cantilever spring 48 into the open position illustrated in FIG. 1B, the receiver 30 is open thereby allowing one to connect or disconnect the attachment or cord C from the carabiner 14. As should be appreciated, when the gate section 28 is released, the cantilever spring 48 biases the gate section 28 back toward the closed position illustrated in FIGS. 1A and 3A.

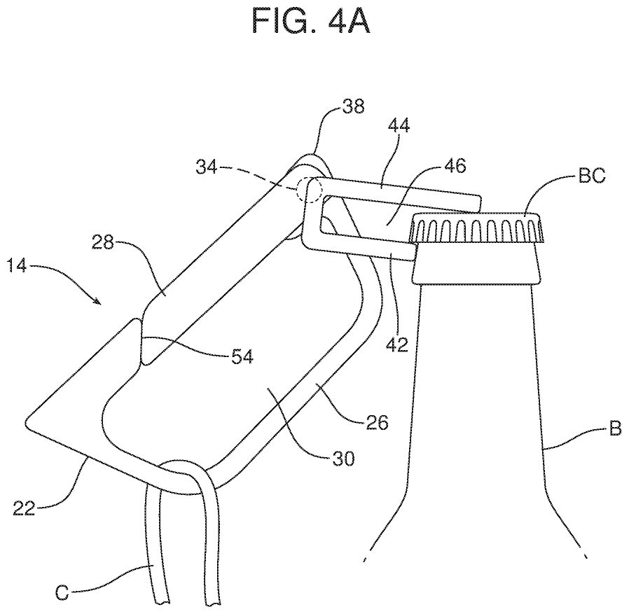

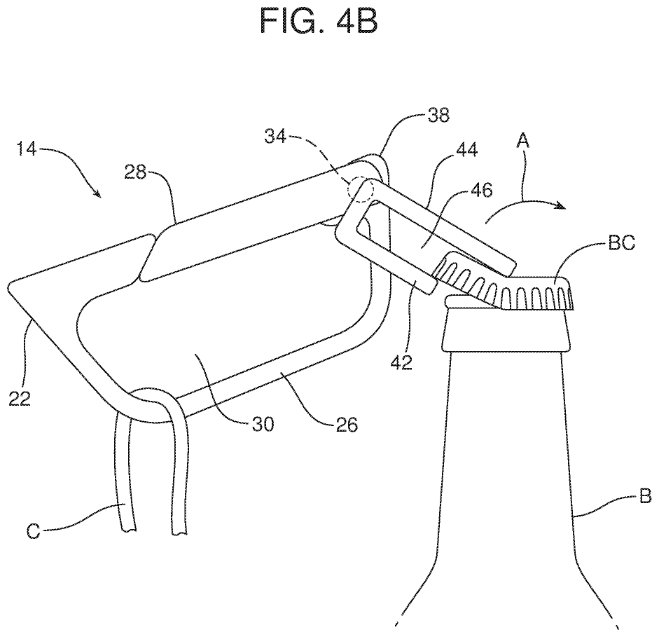

As best illustrated in FIGS. 4A and 4B, the carabiner 14 may be utilized in a method of opening a bottle B. First the carabiner 14 is removed from the trim panel 12 of the motor vehicle by releasing the releasable attachment feature 18. Thus, in the illustrated embodiment the carabiner 14 is pulled sufficiently to overcome the attachment force provided between the magnet 20 and the steel plate 24.

After removing the carabiner 14 from the trim panel 12, the method includes the step of positioning the jaw 46 of the bottle opener feature 40 into engagement with the bottle cap BC on the bottle B (see particularly FIG. 4A). This is then followed by the step of prying the bottle cap BC off of the bottle B using the jaw 46 of the bottle opener feature 40. Toward this end, the carabiner 14 is displaced or pivoted in the direction of action arrow A as illustrated in FIG. 4B.

As illustrated in FIGS. 4A and 4B, it should be appreciated that the method may include opening the bottle B without opening the receiver 30 of the carabiner 14. Accordingly, the method may include the step of opening the bottle B without removing any attachment or cord C from the receiver 30 of the carabiner 14 as shown in FIGS. 4A and 4B.

Alternatively, it should be appreciated that, if desired, the gate section 28 may be removed from the hook section 26 by snapping the trunnion 34 out of the bearing 36 and the pin 52 out of the catch 50. The gate section 28 may then be utilized free of the hook section 26 to open the bottle B with the bottle opener feature 40 in the manner described above and illustrated in FIGS. 4A and 4B.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A carabiner, comprising:
a body having a hook section and a gate section defining a receiver;
a pivot connecting said gate section to said hook section; and
a bottle opener feature carried on and projecting from said gate section outboard of said receiver.

2. The carabiner of claim 1, wherein said bottle opener feature includes (a) a first lug, (b) a second lug and (c) a jaw defined between said first lug and said second lug.

3. The carabiner of claim 2, wherein said first lug is u-shaped.

4. The carabiner of claim 3, wherein said hook section extends through said first lug.

5. The carabiner of claim 4, wherein said second lug is u-shaped.

6. The carabiner of claim 5, wherein said pivot includes a trunnion carried on said gate section and a bearing carried on a first end of said hook section.

7. The carabiner of claim 6, wherein said trunnion extends across said second lug.

8. The carabiner of claim 7, wherein said gate section includes a cantilever spring.

9. The carabiner of claim 8, further including a catch carried on said hook section at said first end adjacent said bearing.

10. The carabiner of claim 9, wherein said cantilever spring includes a pin engaged in said catch.

11. The carabiner of claim 2, wherein said pivot includes a trunnion carried on said gate section and a bearing carried on a first end of said hook section.

12. The carabiner of claim 11, wherein said trunnion extends across said second lug.

13. The carabiner of claim 12, wherein said gate section includes a cantilever spring.

14. The carabiner of claim 13, further including a catch carried on said hook section at said first end adjacent said bearing.

15. The carabiner of claim 14, wherein said cantilever spring includes a pin engaged in said catch.

16. An apparatus, comprising:
a trim panel; and
a carabiner releasably attached to said trim panel, said carabiner including a body having a hook section and a gate section defining a receiver, a pivot connecting said gate section to said hook section and a bottle opener feature projecting from said gate section outboard of said receiver.

17. The apparatus of claim 16, wherein said bottle opener feature includes (a) a first lug, (b) a second lug and (c) a jaw defined between said first lug and said second lug.

18. A method of opening a bottle, comprising:
removing a carabiner from a trim panel of a motor vehicle;
positioning a jaw of a bottle opener feature carried on said carabiner into engagement with a bottle cap on said bottle; and
prying said bottle cap off of said bottle using said jaw.

19. The method of claim 18 including opening said bottle without opening a receiver of said carabiner.

20. The method of claim 18 including opening said bottle without removing any attachment from a receiver of the carabiner.
